(19) United States
(12) Patent Application Publication
(10) Pub. No.: US 2021/0178416 A1
(43) Pub. Date: Jun. 17, 2021

(54) Paint Stream Director for Paint Sprayer

(71) Applicant: Daniel Burke, San Diego, CA (US)

(72) Inventor: Daniel Burke, San Diego, CA (US)

(21) Appl. No.: 17/119,160

(22) Filed: Dec. 11, 2020

Related U.S. Application Data
(60) Provisional application No. 62/946,530, filed on Dec. 11, 2019.

(51) Int. Cl. B05B 12/36; B05B 7/02; B05B 14/30

(52) U.S. Cl. CPC B05B 12/36; B05B 14/30; B05B 7/02

(57) ABSTRACT

An overspray protection device has a housing which is engageable directly to a paint spray gun or to a conduit extending from the paint gun. An interior cavity of the housing provides a pathway for a stream of paint emitted by a spray nozzle to a surface being painted, which is protected from wind by a sidewall defining the shape of the housing and the interior cavity.

This application claims priority to U.S. Provisional Patent Application Ser. No. 62/946,530 filed on Dec. 11, 2019, which is incorporated herein in its entirety by this reference thereto.

### FIELD OF THE INVENTION

The disclosed device concerns paint spraying with compressed and airless sprayers. More particularly, it relates to a removably engageable housing for containing paint spray from a paint spraying gun to a desired area to be painted. The distal edge of the overspray housing may be configured with a brush or roller material thereon, to enable the housing to brush paint sprayed on a surface into uneven areas.

### BACKGROUND OF THE INVENTION

In the field of painting, an airless or compressed air sprayer is frequently used to cover large or uneven areas in place of brushes and rollers. Such spray painting generally accomplishes the painting tasks in an expedited fashion.

However, during the task of spray painting, frequently there can occur wind which will cause portions of the airborne paint from the sprayer to miss the intended surface for the paint being sprayed. Further, in many instances, spray painting surfaces near trim or objects which are not to be painted, causes a problem, especially for non professional painters who may lack the accuracy needed to direct the spray only to surfaces needing paint and to miss those areas and objects not requiring paint.

The device and method herein provide a solution to the perils of wind driven overspray and targeting of paint to adhere only to surfaces needing it.

The forgoing examples of spray painting, and issues regarding such, are intended to be illustrative and not exclusive and they do not imply any limitations on the invention described and claimed herein. Various other limitations of the related art are known or will become apparent to those skilled in the art upon a reading and understanding of the specification below and the accompanying drawings.

### SUMMARY OF THE INVENTION

The device herein, in various preferred modes, provides a solution to overspray and precise targeting issues during spray painting of various surfaces. The device features a housing which has a first end configured to engage either around the discharge of a spray gun or a distal end of an extension conduit which operatively engages the spray gun at a first end thereof.

The housing is preferably formed of fabric, paper, a polymeric material, or a mesh to provide a protective surrounding for the liquid droplets exiting a spray gun during their travel toward and to the surface to be painted. The housing if formed by a sidewall, and in all preferred modes of the device herein, has a first end having a diameter significantly narrower than a distal end thereof. The first end of the housing has a diameter forming a circumference thereof, which is larger than a cross section of the paint spray projected from the fluid nozzle or jet of a paint spraying gun. This allows the spray pattern projecting under pressure from the sprayer fluid nozzle to form the desired linear or other shaped spray pattern upon contact with the surface to be painted adjacent the distal end of the engaged housing.

The housing may be configured at the first end for removable engagement to the spray gun in a manner surrounding the fluid spray nozzle thereof with the sidewall of the housing. In all modes of the device, it is configured for engagement to the spray gun or to a conduit extending therefrom, to surround a conventional fluid spray nozzle which engages with a spray gun. By conventional fluid spray nozzle is meant, for example, those fluid spray nozzles from the BINKS company, which employ a widely used industry standard threaded or bayonet engagement, of the fluid spray nozzle components, with a nozzle connector of a spray gun.

Where not directly engaged to the spray gun, in a mode of the device particularly preferred for painting elevated or hard to reach surfaces, a conduit at a first end may be engaged with the pressurized discharge opening with the paint gun and operatively connected at a second end of the conduit with the housing. The conduit can have the fluid spray nozzle operatively connected at the second end thereof, such that the engagement of the first end of the housing of the device to the second end of the conduit locates the sidewall of the housing of the device to surround the paint spray exiting the fluid spray nozzle at the second end of the conduit

The sidewall of the device herein, forms and defines the shape of the protective housing. The housing is preferably formed in a configuration wherein it widens from the first end thereof, toward the second end. The housing, thus, may be formed in a conical form or a pyramidic form or other configurations forming the first end which is narrow and which expands to a wider second or distal end.

As noted, this configuration forms a passage within the sidewall for communication of the paint from the fluid nozzle of the gun or the conduit, to the surface to be painted. The sidewall, thus in all modes and shapes, protects the pressurized paint exiting the nozzle in a pattern, from wind which will alter the paint pattern causing overspray and waste of paint from wind driven droplets which miss their mark. A skeletal structure can be engaged with the sidewall to hold the sidewall in the desired shape during use where the sidewall is formed of paper or lightweight material.

In a particularly preferred mode of the device, a brush component, such as that formed by horse hair or synthetic bristles, or by a roller having a chosen nap, can be engaged to the sidewall to surround the passage at the distal end of the housing. This mode enables the user to both spray, and concurrently brush or roll the paint reaching the surface being painted. Such a brush component is particularly useful for surfaces such as stucco or uneven wood or the like, which may be uneven or have recesses and ridges. The brush component will allow the user to use the brush component to contact the surface being painted, and to urge the paint to areas which would normally be left uncovered by the liquid spray.

This brush component may be permanently engaged to the distal end of the housing in modes of the device which are disposable. Alternatively, the brush component may be formed in a shape and with a fastener which is complimentary in shape to the sidewall of the housing, at the distal end of the housing. So formed, the brush component can be removably engaged to the housing. This allows for a kit of different brush components formed of differing bristle types or fabric naps, whereby the user can attach one of the brush components from a kit thereof, to the sidewall at the distal end of the housing.

Formation of the sidewall of the housing of a mesh fabric is also preferred to allow the user to view the surface being painted while still protecting the shape of the spray pattern from wind. This mode is especially well suited for painting of surfaces adjacent other surface which are not to be painted since the user can view the surface being painted and paint contact therewith, through the mesh formed sidewall. Such a mesh fabric, for example, is available in insect screen form and other coated mesh fabrics, from the Phifer company of Tuscaloosa, Ala.

With respect to the above description, before explaining at least one preferred embodiment of the paint spray stream protector invention in detail, it is to be understood that the invention is not limited in its application to the details of construction and to the arrangement of the components in the following description or illustrated in the drawings. The invention herein described and shown is capable of other embodiments and of being practiced and carried out in various other ways by those skilled in the art upon reading this disclosure. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other paint spray surrounding housings, and for carrying out the several purposes of the present disclosed device. It is important, therefore, that the claims be regarded as including such equivalent construction and methodology insofar as they do not depart from the spirit and scope of the present invention.

As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements. The term “substantially” when employed herein, means plus or minus twenty percent unless otherwise designated in a different range.

It is an object of the present invention to provide an easily removably engageable paint spray device which eliminates or minimizes overspray of a pressurized paint stream.

It is a further object of this invention to provide such an overspray prevention device, which also includes a permanent or removable distal end which enables the brushing or spreading of paint being sprayed.

These and other objects, features, and advantages of the present overspray protection system, as well as the advantages thereof over existing prior art, which will become apparent from the description to follow, are accomplished by the improvements described in this specification and hereinafter described in the following detailed description which fully discloses the invention, but should not be considered as placing limitations thereon.

### BRIEF DESCRIPTION OF DRAWING FIGURES

The accompanying drawings, which are incorporated herein and form a part of the specification, illustrate some, but not the only or exclusive examples of embodiments and/or features of the disclosed paint overspray protection system and method herein. It is intended that the embodiments and figures disclosed herein are to be considered illustrative of the invention herein, rather than limiting in any fashion.

In the drawings:

FIG. 1 depicts the device in a particularly preferred mode having an overspray housing component which is directly engageable at a first end with a spray gun as in FIG. 1A or which may be engaged to the distal end of a conduit which has a connector thereon to operatively engage a first end with a spray gun.

FIG. 1A shows the device herein in the simplest mode wherein a first end of the overspray housing is connected to a body or component of a spray gun having a nozzle, to position the sidewall to surround the fluid stream emitted by the nozzle of the spray gun which is shown in a cut out portion of the sidewall for clarity.

FIG. 2 shows a perspective view of the housing having a first end engaged with the distal end of the conduit which has a connector at a first end which is operatively engageable to a spray gun.

FIG. 3 shows a mode of the housing body formed by a sidewall with a diameter which widens from a first end to a distal end of the housing, and showing a brush component which may be engaged or removably engageable to the distal end of the body of the housing.

FIG. 4 shows a mode of the device wherein the sidewall of the housing is formed of a mesh material.

FIG. 5 shows the device having a skeletal support engaged with the sidewall.

FIG. 6 depicts a mode of the device in a rectangular shape at the distal end of the sidewall forming the body of the housing.

FIG. 7 shows a view of the sidewall having a secondary layer on an interior surface to absorb paint and prevent dripping.

FIG. 8 shows the sidewall of the device formed in a fan like configuration for additional rigidity and strength during use.

FIG. 9 depicts the device herein in another particularly preferred mode wherein a paint roller is additionally provided and engaged adjacent the distal end of the housing.

FIG. 10 shows the device herein in a similar fashion to that of FIG. 9, wherein the roller is positioned adjacent and parallel to the sidewall forming the housing.

### DETAILED DESCRIPTION OF THE INVENTION

In this description, the directional prepositions of up, upwardly, down, downwardly, front, back, top, upper, bottom, lower, left, right and other such terms refer to the device as it is oriented and appears in the drawings and are used for convenience only and such are not intended to be limiting or to imply that the device has to be used or positioned in any particular orientation.

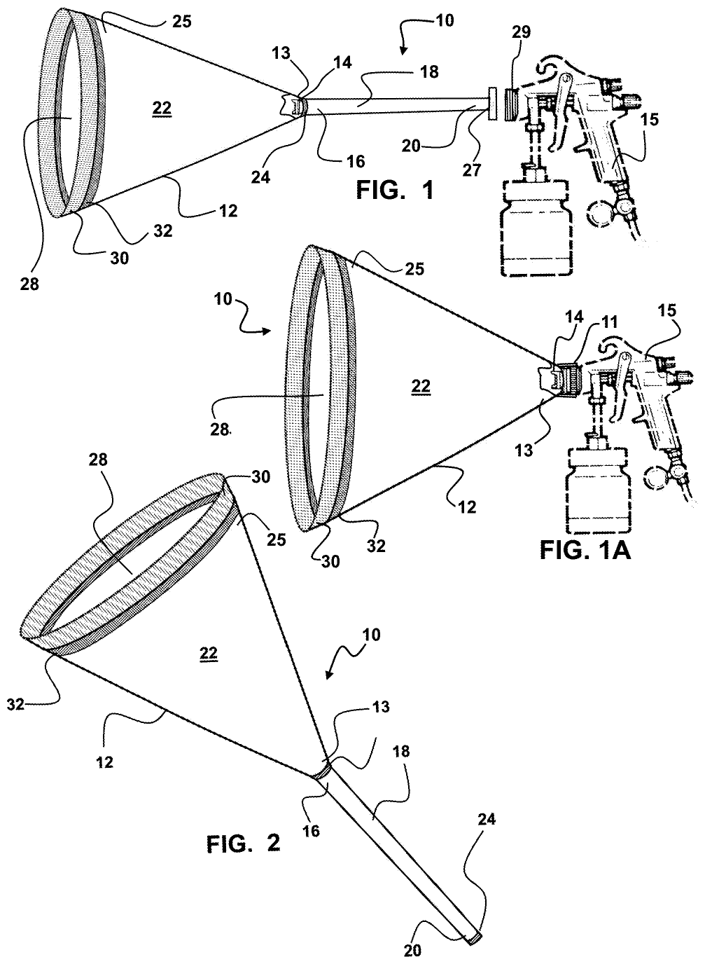

Now referring to drawings in FIGS. 1-10, wherein similar components are identified by like reference numerals, there is seen in FIG. 1 and FIG. 1A, the overspray device 10 herein. The device 10 in all modes features a housing 12 having an interior cavity 28, defined by a sidewall 22. This housing 12, has a connector 11 which is either directly engageable at a first end 13, to an area of a body of the spray gun 15 in a mounted engagement, such that the sidewall 22 surrounds the paint stream emitted from the gun-mounted nozzle 14, which disburses paint from a spray gun 15 as in FIG. 1A. In the alternative, the connector 11 at the first end 13 of the housing 12 may be engaged at or to the distal end 16 of an elongated conduit 18, in the mounted engagement, where the interior cavity 28 surrounds the paint stream projected from the fluid nozzle 14 which is also operatively positioned at the distal end of the conduit 18.

In all modes of the device 10, the interior cavity 28 of the housing 12 defines a pathway for paint sprayed from a fluid nozzle 14. The sidewall 22 protects paint projected from the nozzle 14 through this pathway from communication with wind which might alter the trajectory of the stream of paint as it travels through the pathway of the interior cavity 28 from the first end 13 of the housing 12, to an exit of the paint stream through a second opening 21 at the distal end 25 of the housing 12.

The mode of the device 10 in FIG. 1 provides additional utility through the provision of the extension provided by the conduit 18 for spraying above the head of the user, or for spraying over impediments. However, in some instances, in narrow confines, the mode of the device of FIG. 1A may be preferable.

Where the housing 12 is directly engaged to a spray gun 15, a housing connector 11 at the first end 13 of the housing 12 is configured for a removable engagement of the housing 12 to the gun 15, or as noted below, to a second end of an elongated member 18. That removable engagement using the housing connector 11 will position the housing 12 such that the sidewall 22 surrounds the paint stream dispensed by the fluid nozzle 14 which is connected to the conventional fluid nozzle connector 29 of the spray gun 15 in the conventional fashion. This housing connector 11 for example, and in now way limiting, can be a collar which fractionally engages around an exterior of the conventional nozzle connector 29 at the nozzle end of the gun 15, or may be a housing connector 11 attached to the housing 12 which is complimentary to and connects with a mating connector, on the gun 15, or could be a housing connector 11 which is threaded and operatively engages with a mating threaded connection surrounding the nozzle 14, or it can be any configuration of housing connector 11 as would occur to those skilled in the art, which will removably engage the first end 13 of the housing 12, to the gun 15, and concurrently position the sidewall 22 to surround the paint dispensed by the nozzle 14.

In the particularly preferred mode of the device 10, of FIG. 1, providing the user an extension length for spraying heights and for reaching over impediments to the surface being painted, the first end 13 of the conical or pyramidic housing 12 formed by the sidewall 22, may be configured with a connector 24 to operatively engage the housing first end 13 to the distal end 16, of an elongated conduit 18. This connector 24 may be the same configuration and operation as the above noted housing connector 11, and such would be preferable to allow the user to employ the device easily, with or without the conduit 18.

In this mode of the device 10, the first end 20 of the conduit 18 is configured with a mating connector 27, to operatively engage with the nozzle connector 29 which conventionally operatively engages a fluid nozzle 14, of the spray gun 15 such as the spray fluid nozzles 14 from BINKS company for example.

In this extended mode, the nozzle 14 is operatively positioned at the distal end 16 of the conduit 18 and a mating connector 27, at the first end 20 of the conduit 18, engages with the conventional gun nozzle connector 29 directly or with an adapter. Of course the gun 15 could be modified with a new nozzle connector 29 to engage with one end of a conduit 18, and such is anticipated within the scope of this invention.

Using this engagement of the first end 20 of the conduit 18 to the gun nozzle connector 29, a sealed connection is formed with the pressurized fluid from the spray gun 15, which feeds paint under pressure to the conventionally mounted fluid nozzle 14. With the nozzle 14 removed from the gun 15, the pressurized paint or fluid then communicates through an axial passage of the conduit 18, to the nozzle 14 operatively connected to the distal end 16 of the conduit 18.

The nozzle 14 in this configuration of the device 10 is preferably in a removable engagement to the conduit 18 at the distal end 16 thereof. By removable engagement is meant that the nozzle 14 forms a sealed engagement at the distal end of the conduit 18, such as with a threaded connector or a connector 24 which is configured the same as the gun nozzle connector 29 on the gun 15, so that the nozzle 14 can be connected in a conventional fashion to either the conduit 18 or gun 15, and whereby conventional paint nozzles 14 may be used.

By fluid nozzle 14 herein is meant, those spray nozzle assemblies conventionally employed in the spray painting industry, such as where the nozzle 14 includes a threaded air cap or collar, which threadably connects to a threaded mount such as the nozzle connector 29, and thereby holds a centrally located fluid nozzle component operatively in place. Such an industry standard configuration for example is employed spray guns 15 manufactured by the BINKS company, as well as a number of other manufactures of conventional paint sprayers.

Thus, in the mode of the device 10 of FIG. 1, the gun nozzle 14 is engaged to the conduit 18 at the distal end thereof 16. Preferably, it is a removable engagement where the connector 24 is configured the same as the fluid nozzle connector 29 and is located at the distal end of the conduit 18. Should a replacement be required during use, conventional nozzles 14 used by such spray guns 15, can be placed at the distal end of the conduit 18.

The device, as in FIG. 1, for example, with the conduit 18 engaged between the gun 15 and the nozzle 14, will spray paint from the distal end mounted nozzle 14. The fluid or paint is communicated from the gun 15 through the axial passage (not shown but well known) within the conduit 18. The fluid spray from the nozzle 14 will be disbursed from the nozzle 14 at the distal end 16 of the conduit 18, and will be surrounded by the sidewall 22 forming the housing 12.

In all modes of the device 10 including the conduit 18, complimentary fasteners 24, such as threaded connector, bayonet type connectors, twist and slide connectors, frictional connectors, or other complimentary fasteners 24 that would occur to those skilled in the art, on both the first end 13 of the housing 12 and the distal end 16 of the conduit 18, allow for a removable engagement therebetween which is preferable to allow for replacement. As noted above, where the first end 20 of the conduit 18 connects with the fluid nozzle connector 29 of the spray gun 15 feeding the nozzle 14, the nozzle 14 is operatively engaged to the distal end 16 of the conduit 18. In this engagement at the distal end 16 of the conduit 18, that conduit 18 will preferably have a connector 24 thereon configured the same as the fluid nozzle connector 29 to sealably engage the conventional spray nozzle 14 thereto.

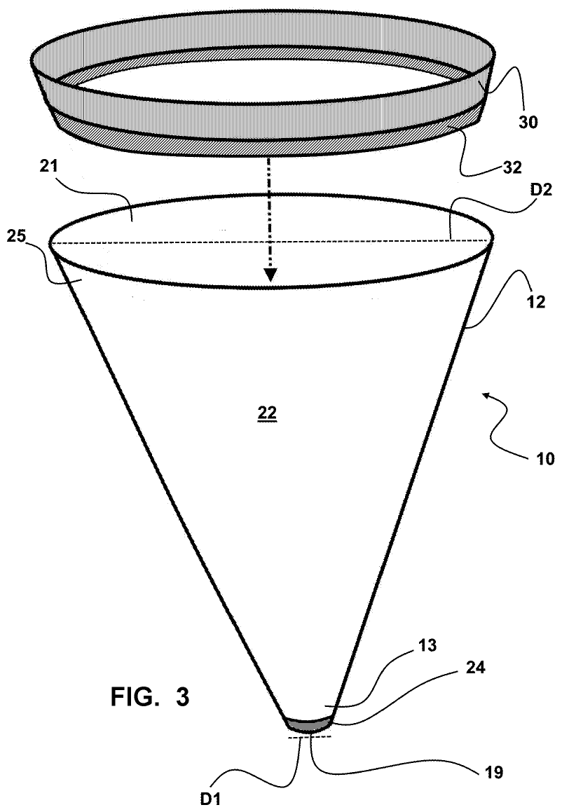

Shown in FIG. 2 is a perspective view of the housing 12 in the mode of the device 10 employing a conduit 18 engaged between the spray gun 15 and the housing 12 in the manner noted above. As shown, the interior cavity 28 at or adjacent a first opening 19 (FIG. 3) at the first end 13 of the housing 12 formed by the sidewall 22, has a first diameter D1 (FIG. 3). This first diameter D1 is significantly smaller than a second diameter D2 (FIG. 3) of the cavity 28, at or adjacent a second opening 21 (FIG. 3) also communicating with the interior cavity 28 at the distal end 25 of the housing 12.

In all preferred modes of the device 10, this housing 12 has such a first diameter D1 of the cavity 28 at or adjacent a first opening 19 at the first end 13 of the housing 12, which is sized to surround the nozzle 14, and which is large enough in the first diameter D1 so as to prevent any interference with the liquid spray pattern being emitted by the nozzle 14. The size or length of this first diameter D1 of course can vary depending on the fluid disbursement pattern emitting from the nozzle 14. Currently, a first diameter D1 of the cavity 28 between 1-4 inches, depending on the spray pattern emitted has been used and worked well. Because the spray patterns of the conventionally commercially sold nozzles 14 are known, the device 10 can easily be configured in multiple sizes to accommodate both the nozzles 14 and their spray pattern in advance for easy sale and use.

In all modes of the device 10, from the first diameter at the first opening at the narrower first end 13 of the housing 12 formed by the sidewall 22, the sidewall 22 will extend in a funnel like shape, such as a cone or pyramid type shape, to the wider second diameter at the second opening at the distal end 25 of the housing 12, which communicates with the interior cavity 18. Thus, the formed housing 12 is preferably of a funnel-like shape and can be frustoconical or pyramidic or some other funnel type shape. By funnel type shape is meant that the sidewall 22 forming the housing 22 defines an interior cavity 28 which is narrower in diameter at or adjacent the first opening at the first end 13 and the cavity 28 has a wider diameter at or adjacent a second opening communicating with the cavity 28, the distal end 25 of the housing 12.

As shown in the figures, to enable the user to brush and spray the surface being painted, it is also preferred to include a brush component 30 engaged with the distal end 25 of the sidewall 22 forming the housing 12. The brush component 30 may be formed of bristles such as from horse hair or synthetic bristles or can be a nap type material as employed on paint rollers or can be another natural or synthetic material adapted to spread sprayed paint on the surface being painted. This brush component 30 can be permanently engaged, or a brush component connector 32 engaged to the brush component 30 on one side can be adapted on the opposite side to connect to the distal end 25 of the housing 12.

For example, the connector 32 can be formed with a recess therein which has a circumference substantially equal to the circumference of the sidewall 22 at the opening to the cavity 28 at the distal end 25 of the housing 12. It can then slide onto position with the sidewall 22 positioned into the recess which can friction fit or have adhesive therein. If formed to removably engage using such a connector 32, the brush component 30 can be provided in a kit form, with a plurality of brush components 30 with differing bristles and nap material therein. This will allow the user to choose and engage the most appropriate brush component 30 for the job at hand, to the housing 12.

Shown in FIG. 3, is a mode of the housing 12 having a body formed by the sidewall 22 with the interior cavity 28 having a diameter which continually widens from a diameter of the cavity 28 at the first end 13 of the housing 12, toward the distal end 25 of the housing 12. Also shown is an detached depiction of the brush component 30 which may be in fixed engagement or removably engageable to the distal end 25 of the body of the housing 12. The sidewall 22 of the housing 12 can be formed of paper or fiberboard or other materials where the device 10 is disposable and may preferably be formed of a mesh or transparent or see-through material as noted herein.

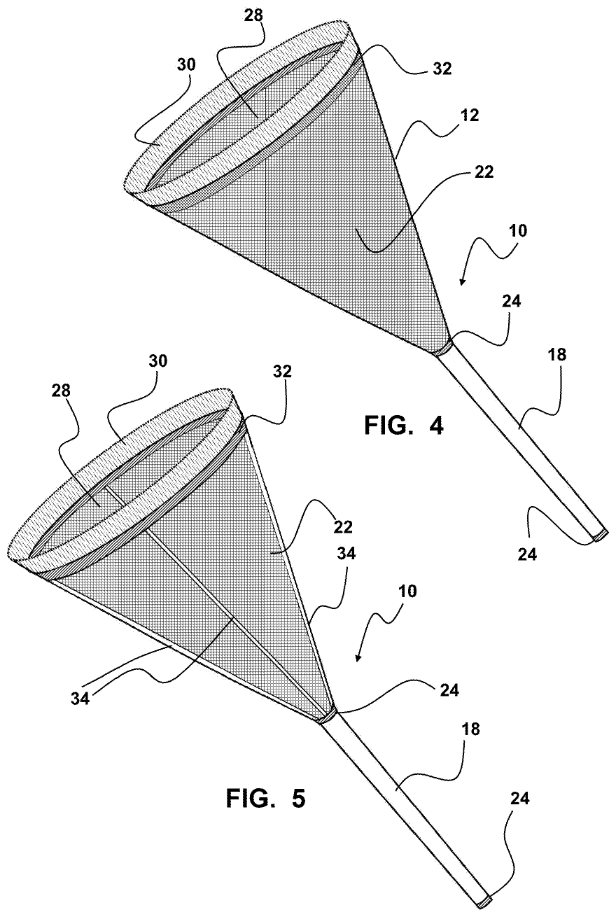

In FIG. 4 is depicted the mode of the device 10 wherein the sidewall 22 of the body of the housing 12 is formed of a see-through material. By see through material is meant a material which has holes or gaps therein or is sufficiently transparent, to allow a user to view the surface being painted, through the sidewall 22.

Such see through material for example includes a sidewall 22 of mesh material such as insect screen or loosely woven material. The housing 12 sidewall 22 can also be formed of substantially transparent polymeric material, such as polyethylene sheeting or a similar polymeric material, to provide increased wind blockage and concurrently provide a see-through sidewall 22 for the user to view the surface being painted during spraying.

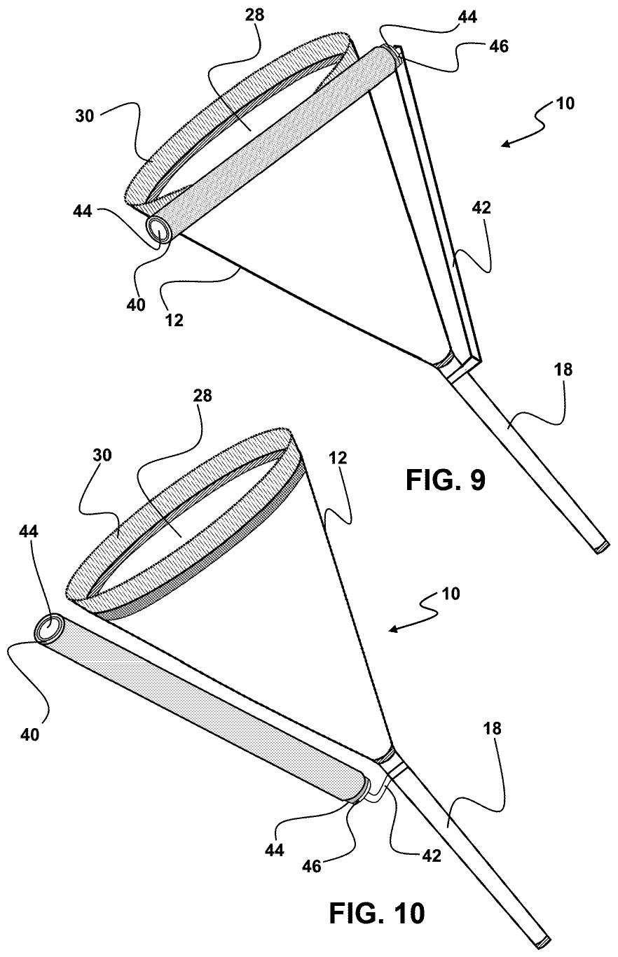

Shown in FIG. 5, the device 10 can also have a housing 12 which is formed with a frame 34 or skeletal support for the sidewall 22 forming the housing 12. The frame 34 supports can be adhered to the sidewall 22 or engaged in formed passages on, or running the length of the sidewall 22. The frame 34 would work especially well when the device 10 is employed to spread paint using a brush component 30, positioned on the end, or where a roller 40 is located adjacent the sidewall 22 as in FIGS. 9-10. In such situations, the frame 34 will impart stiffness and support to keep the sidewall 22 from deforming.

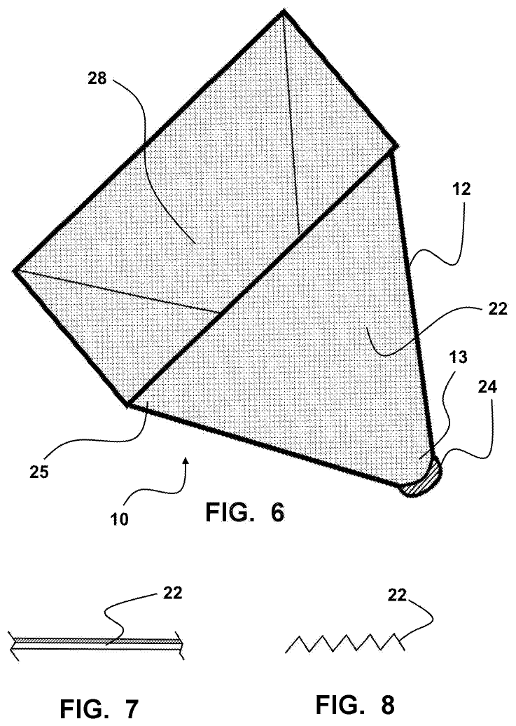

As noted above, in all modes of the device 10 is preferred that the housing 12 have a body formed by a sidewall 22 which defines a funnel-like shape extended from the first diameter of the cavity 28 at the first end 13, to the a second diameter of the cavity at or adjacent the distal end 25 of the housing 12 where an opening communicates with the internal cavity 28. To note that the shape can be funnel-like and not just frustoconical, such a differing funnel-like shape is shown in FIG. 6. As shown, the sidewall 22 forms a housing 12 which is substantially rectangular in the shape of the opening to the internal cavity 28 at the distal end 25 of the sidewall 22 forming the body of the housing 12.

In some modes of the device 10 the sidewall 22 may be formed in multiple layers. As shown in FIG. 7, the sidewall 22 can include a secondary layer on an interior surface such as one formed of material to absorb paint and prevent dripping.

Where additional strength for the sidewall 22 to resist bending and collapse is desired, and where a frame is not employed, forming the sidewall 22 in a zig-zag or fan configuration will give it more stability against bending and collapse during use.

Shown in FIGS. 9-10, is a mode of the device 10 herein, which operates in the same fashion as the above noted configurations, but which includes a paint roller 40. As shown in FIG. 9, the paint roller 40 is rotationally engaged in a position adjacent the housing 12. Such might be directly to the housing 12 if a frame 34 is included, or to a mount 42 connected to the member 18 where the member 18 is included. By rotationally engaged is meant that the paint roller 40 is formed in a conventional fashion by a sleeve which slides onto a member 44, which has a rotational connection 46 to the mount 42. Such a rotational connection for example can be a bearing or similar engagement of the member 44 to the mount 42. In the mode of the device of FIGS. 9-10, the user can roll the roller 40 in contact upon the surface being painted to spread the sprayed paint into cavities and nooks, which may not have adequately received it from the spray. The roller 40 being formed of sleeve which is removably connected to the rotating member 44, allows it to be replaced when worn, or where a larger or smaller nap is needed to spread the paint.

It should be noted that any of the different depicted and described configurations and components of the paint overspray protection device herein, can be employed with any other configuration or component shown and described as part of the device herein. Additionally, while the present invention has been described herein with reference to particular embodiments thereof and/or steps in the method of production or use, a latitude of modifications, various changes and substitutions are intended in the foregoing disclosure, and it will be appreciated that in some instance some features, or configurations, of the invention could be employed without a corresponding use of other features without departing from the scope of the invention as set forth in the following claims. All such changes, alternations and modifications as would occur to those skilled in the art are considered to be within the scope of this invention as broadly defined in the appended claims.

What is claimed is:

1. An overspray protection apparatus, comprising:
a housing, said housing having a sidewall extending from a first end of said housing to a distal end of said housing;
an interior cavity positioned within said sidewall;
said interior cavity having a first diameter at a first opening communicating with said interior cavity at said first end of said housing;
said interior cavity having a second diameter at a second opening located at a second end of said housing, opposite said first end thereof;
said first diameter being smaller than said second diameter;
a connector at said first end of said housing, said connector for forming a mounted engagement of said first end of said housing to a mount of a spray nozzle, said mounted engagement locating said first opening adjacent said spray nozzle for emitting a stream of paint therefrom;
said interior cavity forming a pathway for said stream of paint from said nozzle to a surface being painted, said pathway running through said interior cavity between said first opening to an exit of said paint stream at said second opening; and
said sidewall forming a barrier preventing wind from altering a trajectory of said paint stream while in said pathway.

2. The overspray protection apparatus of claim 1, wherein said mounted engagement formed by said connector is with a spray gun holding said nozzle.

3. The overspray protection apparatus of claim 1 additionally comprising:
a conduit having a first end opposite a distal end of said conduit, said conduit having an axial passage communicating therethrough;
said first end of said conduit configured for a sealed engagement with a fluid nozzle connector of a spray gun;
a spray nozzle mount positioned at said distal end of said conduit, said spray nozzle mount configured for operative engagement of said spray nozzle therein;
said connector at said first end of said housing forming said mounted engagement with said distal end of said conduit; and
said axial passage defining a sealed pathway to said spray nozzle for pressurized paint emitted from said spray gun.

4. The overspray protection apparatus of claim 1 additionally comprising:
a brush component engaged to said sidewall of said housing at said distal end of said housing, whereby said surface being painted can be contacted with said brush component to spread paint from said stream of paint thereon.

5. The overspray protection apparatus of claim 2 additionally comprising:
a brush component engaged to said sidewall of said housing at said distal end of said housing, whereby said surface being painted can be contacted with said brush component to spread paint from said stream of paint thereon.

6. The overspray protection apparatus of claim 3 additionally comprising:
a brush component engaged to said sidewall of said housing at said distal end of said housing, whereby said surface being painted can be contacted with said brush component to spread paint from said stream of paint thereon.

7. The overspray protection apparatus of claim 3 additionally comprising:
a roller engaged, said roller being in a rotational engagement with a mount which is connected to said conduit; and
said roller employable to contact said surface being painted to spread paint from said stream of paint thereon.

8. The overspray protection apparatus of claim 6 additionally comprising:
a roller engaged, said roller being in a rotational engagement with a mount which is connected to said conduit; and
said roller employable to contact said surface being painted to spread paint from said stream of paint thereon.

9. The overspray protection apparatus of claim 1 wherein said housing has a frustoconical shape.

10. The overspray protection apparatus of claim 3 wherein said housing has a frustoconical shape.

11. The overspray protection apparatus of claim 9 wherein said sidewall is formed of see-through material thereby providing a view of said surface being painted through said sidewall.

12. The overspray protection apparatus of claim 10 wherein said sidewall is formed of see-through material thereby providing a view of said surface being painted through said sidewall.
